(19) United States
(12) Patent Application Publication
(10) Pub. No.: US 2024/0021845 A1
(43) Pub. Date: Jan. 18, 2024

(54) STEAM-DRIVEN SOLID OXIDE FUEL CELL ANODE OFF GAS RECIRCULATION EJECTOR SYSTEM WITH WATER RECOVERY

(71) Applicant: CUMMINS INC., Columbus, IN (US)

(72) Inventors: John Robert PENDRAY, Blaine, MN (US); Charles VESELY, Andover, MN (US)

(21) Appl. No.: 18/251,954

(22) PCT Filed: Nov. 23, 2021
(86) PCT No.: PCT/US2021/060467

§ 371 Date: May 5, 2023

Related U.S. Application Data
(60) Provisional application No. 63/118,355, filed on Nov. 25, 2020.

(51) Int. Cl. H01M 8/04007; H01M 8/04089; H01M 8/04701

(52) U.S. Cl. CPC H01M 8/04059; H01M 8/04097; H01M 8/04716

(57) ABSTRACT

A recirculation system for a fuel cell includes a flow splitter operably coupled to an anode of the fuel cell and configured to receive an anode off gas therefrom, a superheater disposed downstream from the flow splitter and configured to cool a portion of the anode off gas received at the flow splitter, and a boiler operably coupled to the superheater and configured to receive the portion of the anode off gas cooled by the superheater, wherein the boiler is configured to generate steam and direct at least a portion of the generated steam to the superheater, and wherein the superheater is configured to use the generated steam to drive an ejector.

### CROSS-REFERENCE TO RELATED APPLICATIONS

This application claims the benefit of and priority, under 35 U.S.C. § 119(e), to U.S. Provisional Patent Application Ser. No. 63/118,355 filed on Nov. 25, 2020, the entire disclosure of which is incorporated herein by reference.

### TECHNICAL FIELD

The present disclosure generally relates to systems and methods for anode off gas recirculation in a fuel cell.

### BACKGROUND

A fuel cell is an electrochemical energy conversion device used in power generation. Common types of fuel cells include phosphoric acid fuel cell (PAFC), molten carbonate fuel cell (MCFC), proton exchange membrane fuel cell (PEMFC), and solid oxide fuel cell (SOFC). Fuel cells, such as SOFCs, may operate in large-scale power generation systems to satisfy industrial and municipal needs. Other types of fuel cells may be useful for smaller portable applications such as, for example, powering vehicles.

A fuel cell includes two electrodes and an electrolyte disposed between them. During operation, electrochemical reactions occur in the fuel cell to convert fuel and oxygen (oxidant) into water or steam (byproduct) and generate electricity. Typically, the electrochemical reactions occur at the electrodes where a catalyst is often disposed to speed up such reactions. The electrodes provide an increased surface area for the electrochemical reactions to occur. The electrolyte transfers electrically charged particles from one electrode to the other electrode and is otherwise substantially impermeable to both the fuel and the oxidant. The byproducts may exit the fuel cell at high operating temperature. The fuel cell system may include a reformer for reforming hydrocarbon fuels by using the byproducts of the fuel cell to produce a reformed stream that may then be circulated to the fuel cell to further improve the efficiency of the fuel cell.

### SUMMARY

A recirculation system for a fuel cell includes a flow splitter operably coupled to an anode of the fuel cell and configured to receive an anode off gas therefrom, a superheater disposed downstream from the flow splitter and configured to cool a portion of the anode off gas received at the flow splitter, and a boiler operably coupled to the superheater and configured to receive the portion of the anode off gas cooled by the superheater, wherein the boiler is configured to generate steam and direct at least a portion of the generated steam to the superheater, and wherein the superheater is configured to use the generated steam to drive an ejector.

A method for recirculating an anode off gas includes receiving, at a flow splitter, the anode off gas generated by an anode of a fuel cell, directing, at the flow splitter, a portion of the received anode off gas to a superheater, cooling, at the superheater, the portion of the anode off gas received from the flow splitter and directing at least a portion of the cooled portion of the anode off gas to a boiler, generating, at the boiler, steam and directing at least a portion of the generated steam to the superheater, and driving an ejector at least in part using the received generated steam.

A recirculation system for a fuel cell includes a superheater comprising a plurality of conduits extending therethrough, a plurality of ejectors, each ejector operably coupled to an output side of the conduit of the superheater and configured to provide a motive force for recirculating an anode off gas output by an anode of the fuel cell, an control valve operably coupled to an input side of at least one conduit of the plurality of conduits of the superheater, wherein, in response to a value of an operating parameter being greater than a threshold, the control valve opens to permit steam to flow to the input side of the at least one conduit of the plurality of conduits, and wherein the superheater drives the ejector operably coupled to the output side of the at least one conduit of the plurality of conduits.

### BRIEF DESCRIPTION OF THE DRAWINGS

The detailed description particularly refers to the following figures, in which:

FIG. 1 is a block diagram illustrating an example anode off gas recirculation system;

FIG. 2 is a block diagram illustrating example ejector arrangements for the recirculation system of FIG. 1;

FIG. 3 is a block diagram illustrating example ejector arrangements for the recirculation system of FIG. 1;

FIG. 4 is a block diagram illustrating example process flows for the recirculation system and ejector arrangements of FIGS. 1-3; and

FIG. 5 is a block diagram illustrating example process flows for the recirculation system and ejector arrangements of FIGS. 1-3.

### DETAILED DESCRIPTION

While the concepts of the present disclosure are susceptible to various modifications and alternative forms, specific exemplary embodiments are been shown by way of example in the drawings and will be described. It should be understood, however, that there is no intent to limit the concepts of the present disclosure to the particular forms disclosed; on the contrary, the intention is to cover all modifications, equivalents, and alternatives falling within the spirit and scope of the invention as defined by the appended claims.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

An anode off gas recirculation system of a solid oxide fuel cell (SOFC) may include a motive force to drive recirculation of the anode off gas. The motive force may be provided by an anode off gas recirculation blower, one or more fuel- or steam-driven ejectors, or some combination of blower and one or more ejector types. In practice, some recirculation motive force solutions are more efficient and cost-effective than others. For example, a blower used to recirculate anode off gas through the fuel cell requires cooling and recuperation of the anode off gas recirculation gases, which adds cost and may, in some cases, reduce overall energy efficiency of the SOFC system. As another example, fuel-driven ejectors, while moderate in cost, require high fuel pressure and may be unable to provide sufficient off gas recirculation rates.

A portion of the anode off gas that is not recirculated, referred to as an anode off gas slip stream, may be mixed with the cathode off gas and oxidized in a catalyst. Certain versions of steam-driven ejectors may rely on the anode off gas recirculation system, rather than on the slip gas, for sufficient water supply, and, therefore, may consume substantial amount of energy, cause an increased pressure loss in the system, or both.

In an off-gas recirculation system of the present disclosure, a superheater disposed before (upstream from) the boiler may extract thermal energy from the anode off gas slip stream before the off-gas is directed into the boiler and condenser. The superheater may establish thermodynamically favorable conditions for a steam-driven ejector, taking advantage of thermal energy abundant in the anode off gas slip stream, while protecting boiler from excessive boiling by ensuring that the amount of thermal energy in the anode off gas slip stream does not exceed a predefined threshold. As such, the superheater of the present disclosure regulates the thermal energy with respect to the amount of water available in the boiler foregoing the need for an external water supply if the slip gas moisture is sufficiently captured in the condenser.

The anode off gas recirculation system of the present disclosure may include one or more steam-driven ejectors configured to selectively engage or disengage based on a value of one or more operating parameters, such as, but not limited to, pressure, system power, system voltage, fuel flow rate, and steam flow rate. For implementations of the recirculation system of the present disclosure having two or more ejectors, the ejectors may be of the same size, different size, or some combination thereof with respect to one another. In one example, size of a given ejector comprises a combination of a first amount of steam input and a second amount of anode gas input to drive the ejector. As such, size of the ejector bears on an output of that ejector as affected by a combination of the first amount and the second amount. In some instances, absolute value of the combined input amount to drive the ejector corresponds to the physical size and/or capacity of that ejector, i.e., an ejector having a larger combined input amount and/or larger output amount may be physically larger than an ejector associated with a smaller combined input amount and/or smaller output amount. In one example, implementing the ejectors of different sizes may allow the amount of steam to vary proportionally with the amount of fuel, enabling passively adaptive system to generate sufficient anode off gas recirculation rates to accommodate changes in fuel flow.

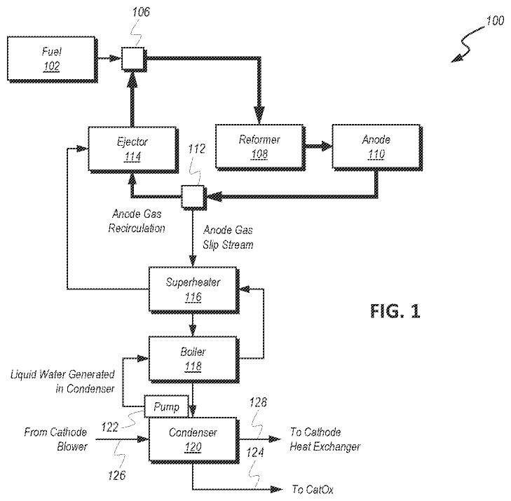

FIG. 1 illustrates an example system 100 for recirculating an anode off gas, such as for use in a fuel cell assembly. The system 100 includes a fuel source 102 that provides fuel, e.g., hydrocarbon, to a reformer 108 via a fuel mixer 106. The reformer 108 may be configured to break down complex hydrocarbons present in the fuel/steam stream and increase calorific value of the fuel/steam. In some examples, a heat exchanger (not shown), such as a high temperature heat exchanger, may be disposed between the fuel mixer 106 and the reformer 108. The heat exchanger may be configured to heat input fuel and recirculated anode off gas received from the fuel mixer 106 to generate a higher energy fuel-rich steam stream prior to outputting/directing the steam stream to the reformer 108. This heat exchanger derives its thermal energy from the Anode outlet before the flow splitter 112.

The reformer 108 outputs hydrogen-rich gas (reformate) stream to an anode 110 of a fuel cell of a fuel cell assembly (e.g., fuel cell system, fuel cell stack, etc.) where hydrogen is oxidized producing electric energy and water. Anode off gas exiting the anode 110 of the fuel cell is a flow splitter 112 operably coupled to an ejector 114 and a superheater 116. The flow splitter 112 is configured to split (or divide) the anode off gas stream into a first portion and a second portion. The flow splitter 112 routes the first portion of the anode off gas, i.e., anode recirculation gas, to the ejector 114 and routes the second portion, i.e., anode slip stream, to the superheater 116.

The ejector 114 may be a steam-driven ejector and may connect to the fuel mixer 106. The ejector 114 causes the anode recirculation gas to be mixed, via the fuel mixer 106, with the input fuel stream directed to the reformer 108 and the inlet of the anode 110.

The superheater 116 receives, from the flow splitter 112, the second portion of the anode off gas, or the anode slip stream. The superheater 116 is configured to lower temperature of the slip stream before the slip stream enters a boiler 118. The superheater 116 directs a cooler slip stream to the boiler 118 that, in turn, generates steam at least a portion of which is directed back to the superheater 116. The superheater 116 directs steam received from the boiler 118 to the ejector 114 for reentry of the anode recirculation loop.

The boiler 118 is configured to direct at least a portion of the cooler slip stream received from the superheater 116 to a condenser 120. The condenser 120 is configured to cause water in the cooler slip stream to condense in a condenser sump pump 122. In some instances, the condenser 120 condenses the water to a predefined dew point associated with the condenser 120. The condenser 120 directs dried cool gas into a cathode oxidizer 124. In one example, a cathode blower 126 may be configured to direct cooling air to the condenser 120 before entering the cathode heat exchanger 128.

The condenser sump pump 122 is configured to pump liquid water to the boiler 118, thereby, providing a water supply internal to the system and alleviating a need for an external water supply. The boiler 118 may include a first float control valve to direct water to the condenser sump pump 122 in response to amount of water in the boiler 118, e.g., as indicated by the float of the first valve, being greater than a predefined amount. The boiler 118 may be operably coupled to a cathode exhaust and/or a water drain line may be configured to spray, or otherwise drain, water in response to excess of water in the condenser sump pump 122, e.g., as indicated by a float of a second float valve, being greater than a threshold amount.

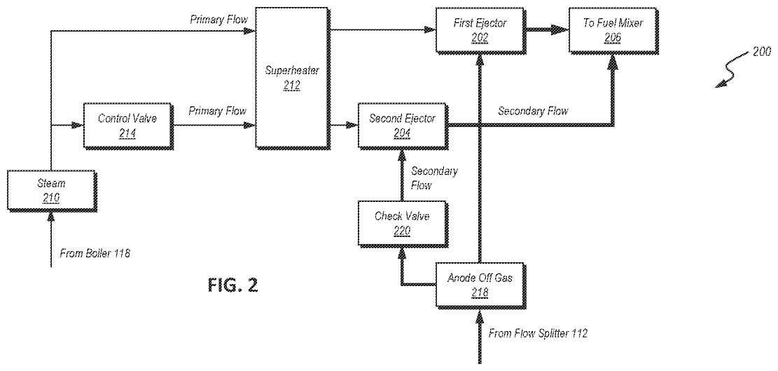

FIG. 2 illustrates an example ejector arrangement 200 for the anode off gas recirculation system of the present disclosure. The arrangement 200 includes a first ejector 202 and a second ejector 204 operably coupled to a fuel mixer 206. Each of the first and second ejectors 202, 204 may be steam-driven. In some instances, a first size of the first ejector 202 may, but need not, be different from a second size of the second ejector 204. In one example, size of a given ejector comprises a combination of a first amount of steam input and a second amount of anode gas input to drive that ejector. As such, size of the ejector bears on either or both a physical size and an output of that ejector as affected by a combination of the first amount and the second amount. In some instances, absolute value of the combined input amount to drive the ejector corresponds to the physical size and/or capacity of that ejector, i.e., an ejector having a larger combined input amount and/or larger output amount may be physically larger than an ejector associated with a smaller combined input amount and/or smaller output amount. Where the first size of the first ejector 202 is different from the second size of the second ejector 204, the first size may be either greater than or less than the second size.

Each of the first and second ejectors 202, 204 may be further operably coupled to a superheater 212. The steam 210 is directed to the superheater 212 that, in turn, directs the steam 210 to at least one ejector of the first ejector 202 or the first ejector 202 and the second ejector 204. Put another way, the superheater 212 is configured to selectively direct the steam 210 between the ejectors 202, 204. The proportion of steam going to 204 and 202 is controlled by the control valve before the superheater.

For example, the first ejector 202 is in direct fluid communication with the steam supply and, at all times, receives all or at least a portion of the steam stream. As such, the first ejector 202 operates as a primary motive force for the anode off gas recirculation. The superheater 212 is operably coupled to a control valve 214, e.g., a pressure control valve or an electronic signal control valve, and receives a portion of the steam 210 therethrough in response to the control valve 214 being open. In one example, the arrangement 200 operates to open the control valve 214, in response to a value of one or more operating parameters of the system, such as, but not limited to, pressure, system power, system voltage, fuel flow rate, and steam flow rate, being greater than a threshold (or in response to a corresponding electronic signal), thereby, driving higher net steam flows. Accordingly, the arrangement 200 is configured to selectively cause the control valve 214 to open to direct a portion of the steam flow 210 to the superheater 212 that, in turn, directs it to the second ejector 204, such that the steam flow 210 is divided between the first ejector 202 and the second ejector 204.

The flow splitter 112 (see FIG. 1) is operably coupled to the first ejector 202 and, at all times, provides all or a portion of anode recirculation gas 218 (e.g., a portion of the anode off gas not directed by the second flow splitter 112 to the superheater 116) directly to the first ejector 202. The flow splitter 112 (see FIG. 1) may be operably coupled to the second ejector 204 via a check valve 220. The check valve 220 may be a passive valve configured to prevent exhaust gases from flowing back toward the second flow splitter 112 when sufficient steam is not flowing through the second ejector 204.

Using a series of ejectors, e.g., the first and second ejectors 202, 204, having different sizes from one another may ensure that each ejector 202, 204 is operating near its own corresponding critical point, e.g., near Mach 1. Mach number M is indicative of a ratio of flow velocity past a boundary to the local speed of sound, as shown in Equation (1), such that:

$$M = \frac{u}{c} , \qquad ( 1 )$$

where M is indicative of the Mach number, u is indicative of a flow velocity with respect to boundaries (either internal, such as an object immersed in the flow, or external, e.g., a channel), and c is indicative of a speed of sound in a given medium. In particular, when the medium is air, the speed of sound c varies with the square root of the thermodynamic temperature. Accordingly, at Mach 1, the local flow velocity u is equal to the speed of sound in the fluid, e.g. steam.

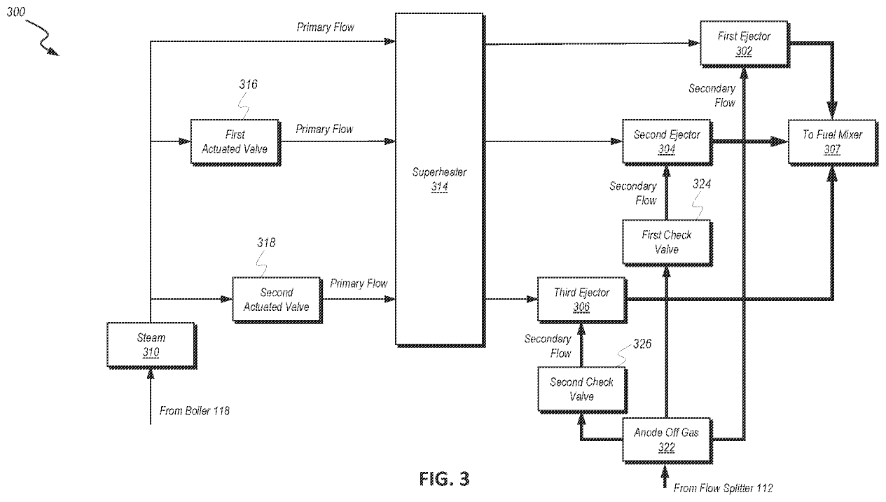

FIG. 3 illustrates an example ejector arrangement 300 for the anode off gas recirculation system of the present disclosure. The arrangement 300 includes a first ejector 302, a second ejector 304, and a third ejector 306 operably coupled to a fuel mixer 307. Each of the first, second, and third ejectors 302, 304, 306 may be steam-driven. In some instances, a first size of the first ejector 302 may, but need not, be different from a second size of the second ejector 304 and/or a third size of the third ejector 306 and the second size may, but need not, be different from the third size, wherein size of a given ejector comprises a combination of a first amount of steam input and a second amount of anode gas input to drive that ejector. Where at least two of the first size, the second size, the third size are different from one another, the first size may be either greater than or less than the second size and may be either greater than or less than the third size and the second size may be either greater than or less than the third size.

The superheater 316 (e.g., in cooperation with the boiler 118, the condenser 120, and the condenser sump pump 122) is configured to provide superheated steam to one or more of the first ejector 302, the second ejector 304, and the third ejector 306. In one example, the steam 310 is selectively divided between the ejectors 302, 304, 306.

The first ejector 302 is in direct fluid communication with the steam supply (via the superheater 314) and, at all times, receives all or at least a portion of the steam stream. The steam 310 enters the superheater 314 via a first control valve 316 to be directed to the second ejector 304. In one example, in response to a value of one or more operating parameters of the system 300, such as, but not limited to, pressure, system power, system voltage, fuel flow rate, and steam flow rate, being greater than a first threshold, the arrangement 300 causes the first control valve 316 to open, thereby, causing a net amount of steam flow to increase. The controls valves 316 and 318 may be spring loaded valves that selectively open with a change in a value of the operating parameter. As another example, one or both of the control valves 316 and 318 may be venturi controlled valves. Additionally or alternatively, one or both of the control valves 316 and 318 may be electronically controlled valves. Put another way, the arrangement 300 is configured to selectively cause the first control valve 316 to open to direct a portion of the steam 310 flow to the conduit of the superheater 314 operably coupled to the second ejector 304, such that the steam flow is divided between the first ejector 302 and the second ejector 304.

The superheater 314 is coupled to the third ejector 306 via a second control valve 318. In response to a value of one or more operating parameters of the system 300, such as, but not limited to, pressure, system power, system voltage, fuel flow rate, and steam flow rate, being greater than a second threshold (or in response to a corresponding electronic signal or command), the arrangement 300 lifts or otherwise operates the second control valve 318 to open (e.g., whether spring actuated or according to a corresponding electronic signal or command) to permit a portion of the steam to flow therethrough, i.e., to cause a net amount of steam flow to increase further. Put another way, the arrangement 300 is configured to selectively cause the second control valve 318 to open to direct a portion of the steam 310 flow to the conduit of the superheater 314 operably coupled to the third ejector 306, such that the superheated steam flow is divided between the first ejector 302 and the third ejector 306. In an example, the first threshold may be less than the second threshold, such that thermodynamic or other operating conditions for opening the first control valve 316 may be met prior to meeting conditions for opening the second control valve 318.

As an example, as the steam flow reduces, caused by a reduction in thermal energy from reduced fuel flow, the pressure of steam 310 reduces, causing the second control valve 318 operably coupled to the third ejector 306 to close (e.g., whether spring actuated or according to a corresponding electronic signal or command), forcing the steam through the first ejector 302 and the second ejector 304 to maintain operation near their optimum operating point. In such an example, if the pressure of the steam 310 flow is further reduced, the pressure of steam 310 reduces proportionally, causing the first control valve 316 operably coupled to the second ejector 304 to close, forcing the steam through the first ejector 302, again, maintaining operation of the first ejector 302 near optimum operating point. Where the system 300 operates according to values of one or more other operating parameters, such as, power, voltage, fuel or steam flow rate, the control valves may open and close in response to corresponding changes in values of those other operating parameters.

The flow splitter 112 is operably coupled to the first ejector 302 and, at all times, provides all or a portion of anode recirculation gas 322 (e.g., a portion of the anode off gas not directed by the second flow splitter 112 to the superheater 314) directly to the first ejector 302. A path of the anode recirculation gas 322 that exits the flow splitter 112 may be operably coupled to the second ejector 304 via a first check valve 324 and operably coupled to the third ejector 306 via a second check valve 326. The check valves 324, 326 may be passive valves configured to prevent exhaust gases from flowing back toward the flow splitter 112 when steam is not going the second and third ejectors 304, 306, respectively.

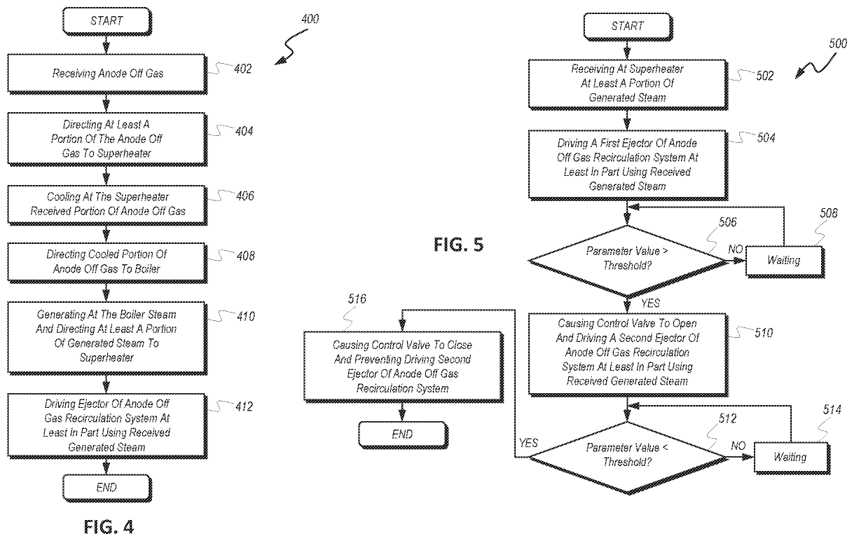

FIG. 4 illustrates an example process 400 for recirculating the anode off gas in accordance to the present disclosure. The process 400 may begin at block 402 where the flow splitter 112 receives the anode off gas from the anode 110. At block 404 the flow splitter 112 directs at least a portion of the anode off gas to the superheater (e.g., the superheater 212 or the superheater 314). The superheater, at block 406, cools the received portion of the anode off gas. The superheater (e.g., the superheater 212 or the superheater 314), at block 408, directs the cooled portion of the anode off gas to the boiler, such as the boiler 118 described in reference to FIG. 1.

The boiler, at block 410, generates steam and directs at least a portion of the generated steam to the superheater of the anode off gas recirculation system. As described in reference to at least FIG. 1, the boiler may comprise the boiler 118 configured to generated the steam from water generated by the condenser sump pump 122 operably coupled to the condenser 120 that is disposed downstream from the boiler 118. At block 412 the superheater is configured to provide steam received from the boiler to drive one or more of the ejectors (e.g., the ejectors 202 and 204 or the ejectors 302 and 304). The process 400 may then end. In some instances, the process 400 may be repeated in response to the second flow splitter 112 receiving the anode off gas or in response to another signal or command.

FIG. 5 illustrates an example process 500 for recirculating an anode off gas in accordance with the present disclosure. The process 500 begins at block 502 where the superheater receives at least a portion of the steam generated by the boiler, wherein the boiler is operably coupled to the condenser in cooperation with the condenser sump pump and is configured to receive water therefrom. At block 504, the superheater drives the first ejector (e.g., the first ejector 202 or the first ejector 302) of the anode off gas recirculation system at least in part using the generated steam received from the boiler.

At block 506 the recirculation system determines whether a value of one or more operating parameters of the system, such as, but not limited to, pressure, system power, system voltage, fuel flow rate, and steam flow rate, is greater than a predefined threshold. If the value is less than the threshold, the system waits a predefined period at block 508 and/or returns to block 506 where the superheater continues to drive the first ejector (e.g., the first ejector 202 or the first ejector 302) of the anode off gas recirculation system at least in part using the generated steam received from the boiler.

In response to detecting at block 506 that the value is greater than a predefined threshold, the anode off gas recirculation system of the present disclosure causes the control valve (e.g., the first control valve 214 or the first control valve 316) to open to permit the steam to flow to conduit of the superheater operably coupled to the second ejector, such that the steam stream is divided between the first ejector and the second ejector. While not separately illustrated, another parameter value threshold check may be performed in a system equipped with the second control valve, such as the control valve 318 described in reference to FIG. 3, that, in turn, connects the superheater to the third ejector. Moreover, an anode off gas recirculation system having three or more control valves operably coupled to the superheater that steam-drives corresponding ejectors are also contemplated.

At block 512 the recirculation system determines whether a value of one or more operating parameters of the system, such as, but not limited to, pressure, system power, system voltage, fuel flow rate, and steam flow rate, is less than a predefined threshold. If the value is greater than the threshold, the system waits a predefined period at block 514 and/or returns to block 512 where the superheater continues to drive both the first ejector (e.g., the first ejector 202 or the first ejector 302) and the second ejector (e.g., the second ejector 304) of the anode off gas recirculation system at least in part using the generated steam received from the boiler. Of course, as would be understood by one of ordinary skill in the art, the anode off gas recirculation system equipped with the second control valve, the system may be configured to determine whether an operating parameter threshold corresponding to the second control valve has been exceed, such that the second control valve may open and the flow of steam may be directed to the superheater and the third ejector operably coupled thereto.

In response to detecting that the operating parameter value is less than a predefined threshold, the anode off gas recirculation system of the present disclosure at block 516 causes the control valve (e.g., the first control valve 214 or the first control valve 316) to close to prevent the steam from flow to conduit of the superheater operably coupled to the second ejector, such that an entire amount of steam is directed to the first ejector. The process 500 may then end. In some instances, the process 500 may be repeated in response to the superheater receiving the steam generated by the boiler or in response to another signal or command.

In accordance with the present disclosure, a superheater is used to remove some of the heat from (lower a temperature of) the slip gas before the slip gas enters the boiler. This implementation increases the effectiveness of the steam in the ejector while also removes heat from the slip stream. Removing heat from the slip stream prevents the heat from overwhelming the boiler and causing excessive boiling, such that an amount of water recovered becomes insufficient to continue effective anode off gas recirculation. Moreover, running at least two ejectors in a configuration consistent with the present disclosure enables operating each ejector near its associated optimum condition, near Mach 1, to maximize the ratio of the anode off gas recirculation mass moved to steam mass consumed over a wider range of conditions.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

The following numbered embodiments are contemplated and are non-limiting.

1. A recirculation system for a fuel cell comprising i) a flow splitter, ii) a superheater, and iii) a boiler.

2. The system of clause 1, any other suitable clause, or any combination of suitable clauses, wherein the recirculation system comprises an anode off gas, a cathode off gas, or an anode off gas slip steam.

3. The system of clause 2, any other suitable clause, or any combination of suitable clauses, wherein the anode off gas slip stream is not recirculated in the recirculation system.

4. The system of clause 2, any other suitable clause, or any combination of suitable clauses, wherein the anode off gas slip stream is mixed with a cathode off gas.

5. The system of clause 2, any other suitable clause, or any combination of suitable clauses, wherein the anode off gas slip stream is oxidized in a catalyst.

6. The system of clause 1, any other suitable clause, or any combination of suitable clauses, wherein the recirculation system comprises a motive force.

7. The system of clause 6, any other suitable clause, or any combination of suitable clauses, wherein the motive force is provided by a blower, one or more ejectors, or some combination of a blower and one or more ejectors.

8. The system of clause 7, any other suitable clause, or any combination of suitable clauses, wherein the blower is an anode off gas recirculation blower.

9. The system of clause 7, any other suitable clause, or any combination of suitable clauses, wherein the one or more ejectors is a fuel-driven ejector or a steam-driven ejector.

10. The system of clause 7, any other suitable clause, or any combination of suitable clauses, wherein the fuel-driven ejector requires high fuel pressure.

11. The system of clause 7, any other suitable clause, or any combination of suitable clauses, wherein the steam-driven ejector does not rely on the anode off gas slip stream.

12. The system of clause 7, any other suitable clause, or any combination of suitable clauses, wherein the steam-driven ejector relies on the anode off gas recirculation system.

13. The system of clause 7, any other suitable clause, or any combination of suitable clauses, wherein the one or more steam-driven ejectors are configured to selectively engage or disengage based on a value of one or more operating parameters.

14. The system of clause 13, any other suitable clause, or any combination of suitable clauses, wherein the one or more operating parameters are pressure, system power, system voltage, fuel flow rate, and steam flow rate.

15. The system of clause 7, any other suitable clause, or any combination of suitable clauses, wherein the ejectors are of a same size, different size, or some combination of ejectors of the same size and different sizes.

16. The system of clause 7, any other suitable clause, or any combination of suitable clauses, wherein a size of each ejector depends on a combination of a first amount of steam input and a second amount of anode gas input to drive each ejector.

17. The system of clause 16, any other suitable clause, or any combination of suitable clauses, wherein an absolute value of the combined input amount to drive the ejector corresponds to the physical size or a capacity of the ejector.

18. The system of clause 16, any other suitable clause, or any combination of suitable clauses, wherein the ejector has a larger combined input amount, output amount, or input and output amount and is physically larger than an ejector with a smaller combined input amount, output amount, or input and output amount.

19. The system of clause 7, any other suitable clause, or any combination of suitable clauses, wherein the one or more ejectors include a first ejector and a second ejector, and/or a third ejector.

20. The system of clause 19, any other suitable clause, or any combination of suitable clauses, wherein a first size of the first ejector is different from or greater than a second size of the second ejector.

21. The system of clause 19, any other suitable clause, or any combination of suitable clauses, wherein a third size of the third ejector is different from the first size, the second size, or the first size and the second size.

22. The system of clause 19, any other suitable clause, or any combination of suitable clauses, wherein the first ejector, the second ejector and the third ejector are operably coupled to the superheater.

23. The system of clause 19, any other suitable clause, or any combination of suitable clauses, wherein the first ejector is in direct fluid communication with the steam supply and receives all or at least a portion of the anode off gas or the anode steam stream.

24. The system of clause 19, any other suitable clause, or any combination of suitable clauses, wherein the first ejector operates as a primary motive force for the recirculation system.

25. The system of clause 7, any other suitable clause, or any combination of suitable clauses, wherein the one or more ejectors of different sizes allow the amount of steam to vary proportionally with the amount of fuel.

26. The system of clause 7, any other suitable clause, or any combination of suitable clauses, wherein the one or more ejectors are operating near their own corresponding critical point or Mach 1.

27. The system of clause 1, any other suitable clause, or any combination of suitable clauses, wherein the recirculation system comprises a fuel source, a reformer, a fuel mixer.

28. The system of clause 27, any other suitable clause, or any combination of suitable clauses, wherein the fuel source provides fuel to the reformer via the fuel mixer.

29. The system of clause 28, any other suitable clause, or any combination of suitable clauses, wherein the fuel is hydrocarbon.

30. The system of clause 27, any other suitable clause, or any combination of suitable clauses, wherein the reformer is configured to break down complex hydrocarbons present in a stream of fuel and steam and to increase a calorific value of the stream of fuel and steam.

31. The system of clause 27, any other suitable clause, or any combination of suitable clauses, wherein the reformer outputs a hydrogen-rich gas or reformate stream to an anode of the fuel cell.

32. The system of clause 27, any other suitable clause, or any combination of suitable clauses, wherein the fuel mixer connects to the one or more steam-driven ejectors.

33. The system of clause 32, any other suitable clause, or any combination of suitable clauses, wherein the one or more steam-driven ejectors cause the anode recirculation gas to be mixed via the fuel mixer with the input fuel stream directed to the reformer and the inlet of the anode.

34. The system of clause 27, any other suitable clause, or any combination of suitable clauses, wherein a heat exchanger is disposed between the fuel mixer and the reformer.

35. The system of clause 34, any other suitable clause, or any combination of suitable clauses, wherein the heat exchanger is a high temperature heat exchanger.

36. The system of clause 34, any other suitable clause, or any combination of suitable clauses, wherein the heat exchanger is configured to heat input fuel and the recirculated anode off gas received from the fuel mixer to generate a higher energy fuel-rich steam stream prior to outputting or directing the steam stream to the reformer.

37. The system of clause 34, any other suitable clause, or any combination of suitable clauses, wherein the heat exchanger derives thermal energy from the anode outlet before the flow splitter.

38. The system of clause 1, any other suitable clause, or any combination of suitable clauses, wherein the fuel cell is a solid oxide fuel cell (SOFC), phosphoric acid fuel cell (PAFC), molten carbonate fuel cell (MCFC), and a proton exchange membrane fuel cell (PEMFC).

39. The system of clause 38, any other suitable clause, or any combination of suitable clauses, wherein the fuel cell is a solid oxide fuel cell (SOFC).

40. The system of clause 38, any other suitable clause, or any combination of suitable clauses, wherein the fuel cell is a proton exchange membrane fuel cell (PEMFC).

41. The system of clause 1, any other suitable clause, or any combination of suitable clauses, wherein the flow splitter is operably coupled to the anode of the fuel cell.

42. The system of clause 1, any other suitable clause, or any combination of suitable clauses, wherein the flow splitter is configured to receive an anode off gas from the anode of the fuel cell.

43. The system of clause 1, any other suitable clause, or any combination of suitable clauses, wherein the flow splitter is operably coupled to the one or more ejectors and the superheater.

44. The system of clause 1, any other suitable clause, or any combination of suitable clauses, wherein the flow splitter is operably coupled to the one or more ejectors and provides all or a portion of the anode off gas directly to the one or more ejectors.

45. The system of clause 1, any other suitable clause, or any combination of suitable clauses, wherein the flow splitter is configured to split or divide the anode off gas into at least two portions.

46. The system of clause 1, any other suitable clause, or any combination of suitable clauses, wherein the flow splitter is configured to split or divide an anode off gas stream into a first portion and a second portion.

47. The system of clause 1, any other suitable clause, or any combination of suitable clauses, wherein the flow splitter allows the first portion of the anode off gas or the anode recirculation gas to one or more ejectors.

48. The system of clause 1, any other suitable clause, or any combination of suitable clauses, wherein the flower splitter allows the second portion of the anode off gas or the anode slip stream to the superheater.

49. The system of clause 1, any other suitable clause, or any combination of suitable clauses, wherein the flow splitter allows the first portion of the anode off gas or the anode recirculation gas to the one or more ejectors and wherein the flower splitter allows the second portion of the anode off gas or the anode slip stream to the superheater.

50. The system of clause 1, any other suitable clause, or any combination of suitable clauses, wherein the flow splitter is operably coupled to the one or more ejectors and provides all or a portion of the anode recirculation gas or the anode off gas directly to the one or more ejector.

51. The system of clause 1, any other suitable clause, or any combination of suitable clauses, wherein the flow splitter is operably coupled to the one or more ejectors and provides all or a portion of the anode recirculation gas or the anode off gas not directed by a second flow splitter to the superheater directly to the one or more ejectors.

52. The system of clause 1, any other suitable clause, or any combination of suitable clauses, wherein the flow splitter is operably coupled to the second ejector via a first check valve and/or is operably coupled to the third ejector via a second check valve.

53. The system of clause 52, any other suitable clause, or any combination of suitable clauses, wherein the first check valve and/or the second check valve is a passive valve configured to prevent exhaust gases from flowing back toward the second flow splitter when sufficient steam is not flowing through the second ejector.

54. The system of clause 1, any other suitable clause, or any combination of suitable clauses, wherein the superheater is located or disposed upstream from the boiler.

55. The system of clause 1, any other suitable clause, or any combination of suitable clauses, wherein the superheater can extract thermal energy from the anode off gas slip stream before the off gas is directed into the boiler or a condenser.

56. The system of clause 55, any other suitable clause, or any combination of suitable clauses, wherein the condenser is configured to cause water in the cooler anode off gas or anode slip stream to condense in a condenser sump pump.

57. The system of clause 56, any other suitable clause, or any combination of suitable clauses, wherein the condenser sump pump is configured to pump liquid water to the boiler.

58. The system of clause 55, any other suitable clause, or any combination of suitable clauses, wherein the condenser condenses the water to a predefined dew point associated with the condenser.

59. The system of clause 55, any other suitable clause, or any combination of suitable clauses, wherein the condenser directs the condensed or dried cool anode off gas or anode slip stream into a cathode oxidizer.

60. The system of clause 55, any other suitable clause, or any combination of suitable clauses, wherein the condenser receives cooling air from a cathode blower before entering a cathode heat exchanger.

61. The system of clause 1, any other suitable clause, or any combination of suitable clauses, wherein the superheater can establish thermodynamically favorable conditions for the steam-driven ejector.

62. The system of clause 1, any other suitable clause, or any combination of suitable clauses, wherein the superheater regulates thermal energy with respect to the amount of water available in the boiler.

63. The system of clause 1, any other suitable clause, or any combination of suitable clauses, wherein the superheater receives the second portion of anode off gas or the anode slip stream from the flow splitter.

64. The system of clause 1, any other suitable clause, or any combination of suitable clauses, wherein the superheater is configured to lower a temperature of the anode off gas or the anode slip stream before the anode off gas or the anode slip stream enters the boiler.

65. The system of clause 1, any other suitable clause, or any combination of suitable clauses, wherein the superheater directs a cooler anode off gas or anode slip stream to the boiler.

66. The system of clause 1, any other suitable clause, or any combination of suitable clauses, wherein the superheater directs steam received from the boiler to the one or more ejectors.

67. The system of clause 1, any other suitable clause, or any combination of suitable clauses, wherein the superheater directs, provides, or is configured to selectively, direct, provide, or divide steam or superheated steam to one or more ejectors, or one or more of the first ejector, the second ejector, and the third ejector.

68. The system of clause 67, any other suitable clause, or any combination of suitable clauses, wherein the steam or superheated steam is selectively divided between the first ejector, the second ejector, and the third ejector.

69. The system of clause 1, any other suitable clause, or any combination of suitable clauses, wherein the superheater is operatively operably coupled to one or more control valves.

70. The system of clause 69, any other suitable clause, or any combination of suitable clauses, wherein the one or more control valves are a pressure control valve or an electronic signal control valve.

71. The system of clause 69, any other suitable clause, or any combination of suitable clauses, wherein the one or more control valves control the proportion of steam going to the first ejector, the second ejector, and/or the third ejector.

72. The system of clause 69, any other suitable clause, or any combination of suitable clauses, wherein the one or more control valves are opened by the first ejector, the second ejector, and/or the third ejector in response to a value of the one or more operating parameters being greater than a threshold or in response to a corresponding electronic signal.

73. The system of clause 69, any other suitable clause, or any combination of suitable clauses, wherein the one or more control valves are selectively opened in response to the first ejector, the second ejector, and/or the third ejector to direct a portion of the steam to the superheater that directs the portion of the steam to the second ejector and/or the third ejector.

74. The system of clause 69, any other suitable clause, or any combination of suitable clauses, wherein the one or more control valves include a first control valve and/or a second control valve.

75. The system of clause 74, any other suitable clause, or any combination of suitable clauses, wherein the first control valve and/or the second control valve open and close in response to corresponding changes in values of one or more operating parameters.

76. The system of clause 74, any other suitable clause, or any combination of suitable clauses, wherein the first control valve and/or the second control valve is opened in response to a value of the one or more operating parameters being greater than a first threshold and/or second threshold, a corresponding electronic signal, or a corresponding electronic command.

77. The system of clause 76, any other suitable clause, or any combination of suitable clauses, wherein the first threshold is less than the second threshold.

78. The system of clause 74, any other suitable clause, or any combination of suitable clauses, wherein the first control valve and/or the second control valve is selectively opened to direct a portion of a steam flow to the conduit of the superheater operably coupled to the second ejector and/or the third ejector.

79. The system of clause 78, any other suitable clause, or any combination of suitable clauses, wherein the steam flow is divided between the first ejector, the second ejector, and/or the third ejector.

80. The system of clause 74, any other suitable clause, or any combination of suitable clauses, wherein the first control valve operably coupled to the second ejector or the second control valve operably coupled to the third ejector closes due to a reduction or proportional reduction in a pressure of the steam.

81. The system of clause 69, any other suitable clause, or any combination of suitable clauses, wherein the one or more control valves are spring loaded valves that selectively open with a change in a value of the one or more operating parameters, venturi controlled valves, or electronically controlled valves.

82. The system of clause 1, any other suitable clause, or any combination of suitable clauses, wherein the superheater receives a portion of the steam in response to the one or more control valves being open.

83. The system of clause 1, any other suitable clause, or any combination of suitable clauses, wherein the superheater is coupled to the second ejector via the first control valve and/or is coupled to the third ejector via the second control valve.

84. The system of clause 1, any other suitable clause, or any combination of suitable clauses, wherein the boiler is configured to generate steam.

85. The system of clause 84, any other suitable clause, or any combination of suitable clauses, wherein at least a portion of the generated steam is directed back to the superheater

86. The system of clause 84, any other suitable clause, or any combination of suitable clauses, wherein the steam is divided between one or more ejector, or one or more of the first ejector, the second ejector, and the third ejector.

87. The system of clause 1, any other suitable clause, or any combination of suitable clauses, wherein the boiler is configured to direct at least a portion of the cooler anode off gas or anode slip stream to the condenser.

88. The system of clause 1, any other suitable clause, or any combination of suitable clauses, wherein the boiler includes a first float control valve to direct water to the condenser sump pump in response to the amount of water in the boiler being greater than a predefined amount as indicated by a float of the first float valve.

89. The system of clause 1, any other suitable clause, or any combination of suitable clauses, wherein the boiler is operably coupled to a cathode exhaust, a water drain line, or a cathode exhaust and a water drain line configured to spray or drain water in response to excess water in the condenser sump pump being greater than a threshold amount as indicated by a float of a second float control valve.

90. The system of clause 1, any other suitable clause, or any combination of suitable clauses, wherein the recirculation system is implemented in hardware, firmware, software or a combination of hardware, firmware, and/or software.

91. The system of clause 1, any other suitable clause, or any combination of suitable clauses, wherein the recirculation system is implemented as instructions carried by or stored on one or more transitory or non-transitory machine-readable storage mediums and/or one or more transitory or non-transitory computer-readable storage mediums

92. The system of clause 91, any other suitable clause, or any combination of suitable clauses, wherein the one or more transitory or non-transitory machine-readable storage mediums are any storage device, mechanism, or other physical structure for storing or transmitting information in a form readable by a machine, a volatile or non-volatile memory, a media disc, another media device, or any combination of the above.

93. The system of clause 91, any other suitable clause, or any combination of suitable clauses, wherein the one or more transitory or non-transitory computer-readable storage mediums are any storage device, mechanism, or other physical structure for storing or transmitting information in a form readable by a computer, a volatile or non-volatile memory, a media disc, another media device, or any combination of the above.

94. The system of clause 91, any other suitable clause, or any combination of suitable clauses, wherein the one or more transitory or non-transitory machine-readable storage mediums and/or the one or more transitory or non-transitory computer-readable storage mediums are read and executed by one or more processors.

95. A method for recirculating an anode off gas comprising i) receiving the anode off gas at a flow splitter, ii) directing a portion of the anode off gas at the flow splitter to a superheater, iii) cooling the portion of the anode off gas at the superheater, iv) directing at least a portion of the cooled portion of the anode off gas at the superheater to a boiler, v) generating steam at the boiler, vi) directing at least a portion of the generated steam at the boiler to the superheater, and vii) driving an ejector at least in part using the generated steam.

96. The method of clause 95, any other suitable clause, or any combination of suitable clauses, wherein the method is repeated in response to a second flow splitter receiving the anode off gas or in response to another signal or command

97. The method of clause 95, any other suitable clause, or any combination of suitable clauses, wherein the method further comprises determining whether a value of one or more operating parameters is greater than a predefined threshold.

98. The method of clause 97, any other suitable clause, or any combination of suitable clauses, wherein the one or more operating parameters are pressure, system power, system voltage, fuel flow rate, and steam flow rate.

99. The method of clause 97, any other suitable clause, or any combination of suitable clauses, wherein the method further comprises waiting a predefined period, returning to the superheater driving at least one ejector at least in part using the generated steam if the value is less than the predefined threshold.

100. The method of clause 97, any other suitable clause, or any combination of suitable clauses, wherein the method further comprises opening a control valve operably coupled to the superheater to permit the generated steam to flow to conduit of the superheater operably coupled to a second ejector if the value is greater than the predefined threshold.

101. The method of clause 95, any other suitable clause, or any combination of suitable clauses, wherein the anode off gas slip stream is mixed with a cathode off gas.

102. The method of clause 95, any other suitable clause, or any combination of suitable clauses, wherein the anode off gas slip stream is oxidized in a catalyst.

103. The method of clause 95, any other suitable clause, or any combination of suitable clauses, wherein the anode off gas slip stream is not recirculated in a recirculation system.

104. The method of clause 103, any other suitable clause, or any combination of suitable clauses, wherein the recirculation system comprises the anode off gas, a cathode off gas, or an anode off gas slip steam.

105. The method of clause 103, any other suitable clause, or any combination of suitable clauses, wherein the recirculation system comprises a motive force.

106. The method of clause 105, any other suitable clause, or any combination of suitable clauses, wherein the motive force is provided by a blower, one or more ejectors, or some combination of a blower and one or more ejectors.

107. The method of clause 105, any other suitable clause, or any combination of suitable clauses, wherein the blower is an anode off gas recirculation blower.

108. The method of clause 103, any other suitable clause, or any combination of suitable clauses, wherein the recirculation system comprises a fuel source, a reformer, a fuel mixer.

109. The method of clause 108, any other suitable clause, or any combination of suitable clauses, wherein the fuel source provides fuel to the reformer via the fuel mixer.

110. The method of clause 109, any other suitable clause, or any combination of suitable clauses, wherein the fuel is hydrocarbon.

111. The method of clause 108, any other suitable clause, or any combination of suitable clauses, wherein the reformer is configured to break down complex hydrocarbons present in a stream of fuel and steam and to increase a calorific value of the stream of fuel and steam.

112. The method of clause 108, any other suitable clause, or any combination of suitable clauses, wherein the reformer outputs a hydrogen-rich gas or reformate stream to an anode of a fuel cell.

113. The method of clause 109, any other suitable clause, or any combination of suitable clauses, wherein the fuel cell is a solid oxide fuel cell (SOFC), phosphoric acid fuel cell (PAFC), molten carbonate fuel cell (MCFC), and a proton exchange membrane fuel cell (PEMFC).

114. The method of clause 113, any other suitable clause, or any combination of suitable clauses, wherein the fuel cell is a solid oxide fuel cell (SOFC).

115. The method of clause 113, any other suitable clause, or any combination of suitable clauses, wherein the fuel cell is a proton exchange membrane fuel cell (PEMFC).

116. The method of clause 108, any other suitable clause, or any combination of suitable clauses, wherein the fuel mixer connects to the one or more steam-driven ejectors.

117. The method of clause 116, any other suitable clause, or any combination of suitable clauses, wherein the one or more steam-driven ejectors cause the anode recirculation gas to be mixed via the fuel mixer with the input fuel stream directed to the reformer and the inlet of the anode.

118. The method of clause 108, any other suitable clause, or any combination of suitable clauses, wherein a heat exchanger is disposed between the fuel mixer and the reformer.

119. The method of clause 118, any other suitable clause, or any combination of suitable clauses, wherein the heat exchanger is a high temperature heat exchanger.

120. The method of clause 118, any other suitable clause, or any combination of suitable clauses, wherein the heat exchanger is configured to heat input fuel and the recirculated anode off gas received from the fuel mixer to generate a higher energy fuel-rich steam stream prior to outputting or directing the steam stream to the reformer.

121. The method of clause 118, any other suitable clause, or any combination of suitable clauses, wherein the heat exchanger derives thermal energy from the anode outlet before the flow splitter

122. The method of clause 103, any other suitable clause, or any combination of suitable clauses, wherein the recirculation system is implemented in hardware, firmware, software or a combination of hardware, firmware, and/or software.

123. The method of clause 103, any other suitable clause, or any combination of suitable clauses, wherein the recirculation system is implemented as instructions carried by or stored on one or more transitory or non-transitory machine-readable storage mediums and/or one or more transitory or non-transitory computer-readable storage mediums

124. The method of clause 123, any other suitable clause, or any combination of suitable clauses, wherein the one or more transitory or non-transitory machine-readable storage mediums are any storage device, mechanism, or other physical structure for storing or transmitting information in a form readable by a machine, a volatile or non-volatile memory, a media disc, another media device, or any combination of the above.

125. The method of clause 123, any other suitable clause, or any combination of suitable clauses, wherein the one or more transitory or non-transitory computer-readable storage mediums are any storage device, mechanism, or other physical structure for storing or transmitting information in a form readable by a computer, a volatile or non-volatile memory, a media disc, another media device, or any combination of the above.

126. The method of clause 123, any other suitable clause, or any combination of suitable clauses, wherein the one or more transitory or non-transitory machine-readable storage mediums and/or the one or more transitory or non-transitory computer-readable storage mediums are read and executed by one or more processors.

127. The method of clause 95, any other suitable clause, or any combination of suitable clauses, wherein the flow splitter is operably coupled to the anode of the fuel cell.

128. The method of clause 95, any other suitable clause, or any combination of suitable clauses, wherein the flow splitter is configured to receive an anode off gas from the anode of the fuel cell.

129. The method of clause 95, any other suitable clause, or any combination of suitable clauses, wherein the flow splitter is operably coupled to the one or more ejectors and the superheater.

130. The method of clause 95, any other suitable clause, or any combination of suitable clauses, wherein the flow splitter is operably coupled to the one or more ejectors and provides all or a portion of the anode off gas directly to the one or more ejectors.

131. The method of clause 95, any other suitable clause, or any combination of suitable clauses, wherein the flow splitter is configured to split or divide the anode off gas into at least two portions.

132. The method of clause 95, any other suitable clause, or any combination of suitable clauses, wherein the flow splitter is configured to split or divide an anode off gas stream into a first portion and a second portion.

133. The method of clause 95, any other suitable clause, or any combination of suitable clauses, wherein the flow splitter allows the first portion of the anode off gas or the anode recirculation gas to one or more ejectors.

134. The method of clause 95, any other suitable clause, or any combination of suitable clauses, wherein the flower splitter allows the second portion of the anode off gas or the anode slip stream to the superheater.

135. The method of clause 95, any other suitable clause, or any combination of suitable clauses, wherein the flow splitter allows the first portion of the anode off gas or the anode recirculation gas to the one or more ejectors and wherein the flower splitter allows the second portion of the anode off gas or the anode slip stream to the superheater.

136. The method of clause 95, any other suitable clause, or any combination of suitable clauses, wherein the flow splitter is operably coupled to the one or more ejectors and provides all or a portion of the anode recirculation gas or the anode off gas directly to the one or more ejectors.

137. The method of clause 95, any other suitable clause, or any combination of suitable clauses, wherein the flow splitter is operably coupled to the one or more ejectors and provides all or a portion of the anode recirculation gas or the anode off gas not directed by a second flow splitter to the superheater directly to the one or more ejectors.

138. The method of clause 95, any other suitable clause, or any combination of suitable clauses, wherein the flow splitter is operably coupled to the second ejector via a first check valve and/or is operably coupled to the third ejector via a second check valve.

139. The method of clause 138, any other suitable clause, or any combination of suitable clauses, wherein the first check valve and/or the second check valve is a passive valve configured to prevent exhaust gases from flowing back toward the second flow splitter when sufficient steam is not flowing through the second ejector.

140. The method of clause 95, any other suitable clause, or any combination of suitable clauses, wherein the superheater is located or disposed upstream from the boiler.

141. The method of clause 95, any other suitable clause, or any combination of suitable clauses, wherein the superheater can extract thermal energy from the anode off gas slip stream before the off gas is directed into the boiler or a condenser.

142. The method of clause 141, any other suitable clause, or any combination of suitable clauses, wherein the condenser is configured to cause water in the cooler anode off gas or anode slip stream to condense in a condenser sump pump.

143. The method of clause 142, any other suitable clause, or any combination of suitable clauses, wherein the condenser sump pump is configured to pump liquid water to the boiler.

144. The method of clause 141, any other suitable clause, or any combination of suitable clauses, wherein the condenser condenses the water to a predefined dew point associated with the condenser.

145. The method of clause 141, any other suitable clause, or any combination of suitable clauses, wherein the condenser directs the condensed or dried cool anode off gas or anode slip stream into a cathode oxidizer.

146. The method of clause 141, any other suitable clause, or any combination of suitable clauses, wherein the condenser receives cooling air from a cathode blower before entering a cathode heat exchanger.

147. The method of clause 95, any other suitable clause, or any combination of suitable clauses, wherein the superheater can establish thermodynamically favorable conditions for the steam-driven ejector.

148. The method of clause 95, any other suitable clause, or any combination of suitable clauses, wherein the superheater regulates thermal energy with respect to the amount of water available in the boiler.

149. The method of clause 95, any other suitable clause, or any combination of suitable clauses, wherein the superheater receives the second portion of anode off gas or the anode slip stream from the flow splitter.

150. The method of clause 95, any other suitable clause, or any combination of suitable clauses, wherein the superheater is configured to lower a temperature of the anode off gas or the anode slip stream before the anode off gas or the anode slip stream enters the boiler.

151. The method of clause 95, any other suitable clause, or any combination of suitable clauses, wherein the superheater directs a cooler anode off gas or anode slip stream to the boiler.

152. The method of clause 95, any other suitable clause, or any combination of suitable clauses, wherein the superheater directs steam received from the boiler to the one or more ejectors.

153. The method of clause 95, any other suitable clause, or any combination of suitable clauses, wherein the superheater directs, provides, or is configured to selectively, direct, provide, or divide steam or superheated steam to one or more ejectors, or one or more of the first ejector, the second ejector, and the third ejector.

154. The method of clause 153, any other suitable clause, or any combination of suitable clauses, wherein the steam or superheated steam is selectively divided between the first ejector, the second ejector, and the third ejector.

155. The method of clause 95, any other suitable clause, or any combination of suitable clauses, wherein the superheater is operatively operably coupled to one or more control valves.

156. The method of clause 155, any other suitable clause, or any combination of suitable clauses, wherein the one or more control valves are a pressure control valve or an electronic signal control valve.

157. The method of clause 155, any other suitable clause, or any combination of suitable clauses, wherein the one or more control valves control the proportion of steam going to the first ejector, the second ejector, and/or the third ejector.

158. The method of clause 155, any other suitable clause, or any combination of suitable clauses, wherein the one or more control valves are opened by the first ejector, the second ejector, and/or the third ejector in response to a value of the one or more operating parameters being greater than a threshold or in response to a corresponding electronic signal.

159. The method of clause 155, any other suitable clause, or any combination of suitable clauses, wherein the one or more control valves are selectively opened in response to the first ejector, the second ejector, and/or the third ejector to direct a portion of the steam to the superheater that directs the portion of the steam to the second ejector and/or the third ejector.

160. The method of clause 155, any other suitable clause, or any combination of suitable clauses, wherein the one or more control valves include a first control valve and/or a second control valve.

161. The method of clause 160, any other suitable clause, or any combination of suitable clauses, wherein the first control valve and/or the second control valve open and close in response to corresponding changes in values of one or more operating parameters.

162. The method of clause 160, any other suitable clause, or any combination of suitable clauses, wherein the first control valve and/or the second control valve is opened in response to a value of the one or more operating parameters being greater than a first threshold and/or second threshold, a corresponding electronic signal, or a corresponding electronic command.

163. The method of clause 162, any other suitable clause, or any combination of suitable clauses, wherein the first threshold is less than the second threshold.

164. The method of clause 160, any other suitable clause, or any combination of suitable clauses, wherein the first control valve and/or the second control valve is selectively opened to direct a portion of a steam flow to the conduit of the superheater operably coupled to the second ejector and/or the third ejector.

165. The method of clause 164, any other suitable clause, or any combination of suitable clauses, wherein the steam flow is divided between the first ejector, the second ejector, and/or the third ejector.

166. The method of clause 160, any other suitable clause, or any combination of suitable clauses, wherein the first control valve operably coupled to the second ejector or the second control valve operably coupled to the third ejector closes due to a reduction or proportional reduction in a pressure of the steam.

167. The method of clause 155, any other suitable clause, or any combination of suitable clauses, wherein the one or more control valves are spring loaded valves that selectively open with a change in a value of the one or more operating parameters, venturi controlled valves, or electronically controlled valves.

168. The method of clause 95, any other suitable clause, or any combination of suitable clauses, wherein the superheater receives a portion of the steam in response to the one or more control valves being open.

169. The method of clause 95, any other suitable clause, or any combination of suitable clauses, wherein the superheater is coupled to the second ejector via the first control valve and/or is coupled to the third ejector via the second control valve.

170. The method of clause 95, any other suitable clause, or any combination of suitable clauses, wherein the boiler is configured to generate steam.

171. The method of clause 170, any other suitable clause, or any combination of suitable clauses, wherein at least a portion of the generated steam is directed back to the superheater

172. The method of clause 170, any other suitable clause, or any combination of suitable clauses, wherein the steam is divided between one or more ejector, or one or more of the first ejector, the second ejector, and the third ejector.

173. The method of clause 95, any other suitable clause, or any combination of suitable clauses, wherein the boiler is configured to direct at least a portion of the cooler anode off gas or anode slip stream to the condenser.

174. The method of clause 95, any other suitable clause, or any combination of suitable clauses, wherein the boiler includes a first float control valve to direct water to the condenser sump pump in response to the amount of water in the boiler being greater than a predefined amount as indicated by a float of the first float valve.

175. The method of clause 95, any other suitable clause, or any combination of suitable clauses, wherein the boiler is operably coupled to a cathode exhaust, a water drain line, or a cathode exhaust and a water drain line configured to spray or drain water in response to excess water in the condenser sump pump being greater than a threshold amount as indicated by a float of a second float control valve.

176. The method of clause 95, any other suitable clause, or any combination of suitable clauses, wherein the ejector includes one or more ejectors.

177. The method of clause 176, any other suitable clause, or any combination of suitable clauses, wherein the one or more ejectors are a fuel-driven ejector or a steam-driven ejector.

178. The method of clause 176, any other suitable clause, or any combination of suitable clauses, wherein the fuel-driven ejector requires high fuel pressure.

179. The method of clause 176, any other suitable clause, or any combination of suitable clauses, wherein the steam-driven ejector does not rely on the anode off gas slip stream.

180. The method of clause 176, any other suitable clause, or any combination of suitable clauses, wherein the steam-driven ejector relies on the anode off gas recirculation system.

181. The method of clause 176, any other suitable clause, or any combination of suitable clauses, wherein the one or more steam-driven ejectors are configured to selectively engage or disengage based on a value of one or more operating parameters.

182. The method of clause 181, any other suitable clause, or any combination of suitable clauses, wherein the one or more operating parameters are pressure, system power, system voltage, fuel flow rate, and steam flow rate.

183. The method of clause 176, any other suitable clause, or any combination of suitable clauses, wherein the ejectors are of a same size, different size, or some combination of ejectors of the same size and different sizes.

184. The method of clause 176, any other suitable clause, or any combination of suitable clauses, wherein a size of each ejector depends on a combination of a first amount of steam input and a second amount of anode gas input to drive each ejector.

185. The method of clause 184, any other suitable clause, or any combination of suitable clauses, wherein an absolute value of the combined input amount to drive the ejector corresponds to the physical size or a capacity of the ejector.

186. The method of clause 184, any other suitable clause, or any combination of suitable clauses, wherein the ejector has a larger combined input amount, output amount, or input and output amount and is physically larger than an ejector with a smaller combined input amount, output amount, or input and output amount.

187. The method of clause 176, any other suitable clause, or any combination of suitable clauses, wherein the one or more ejectors include a first ejector and a second ejector, and/or a third ejector.

188. The method of clause 187, any other suitable clause, or any combination of suitable clauses, wherein a first size of the first ejector is different from or greater than a second size of the second ejector.

189. The method of clause 187, any other suitable clause, or any combination of suitable clauses, wherein a third size of the third ejector is different from the first size, the second size, or the first size and the second size.

190. The method of clause 187, any other suitable clause, or any combination of suitable clauses, wherein the first ejector, the second ejector and the third ejector are operably coupled to the superheater.

191. The method of clause 187, any other suitable clause, or any combination of suitable clauses, wherein the first ejector is in direct fluid communication with the steam supply and receives all or at least a portion of the anode off gas or the anode steam stream.

192. The method of clause 187, any other suitable clause, or any combination of suitable clauses, wherein the first ejector operates as a primary motive force for the recirculation system.

193. The method of clause 176, any other suitable clause, or any combination of suitable clauses, wherein the one or more ejectors of different sizes allow the amount of steam to vary proportionally with the amount of fuel.

194. The method of clause 176, any other suitable clause, or any combination of suitable clauses, wherein the one or more ejectors are operating near their own corresponding critical point or Mach 1.

195. A recirculation system for a fuel cell comprising i) a superheater, ii) at least one ejector, and iii) a control valve

196. The system of clause 195, any other suitable clause, or any combination of suitable clauses, wherein the recirculation system comprises an anode off gas, a cathode off gas, or an anode off gas slip steam.

197. The system of clause 196, any other suitable clause, or any combination of suitable clauses, wherein the anode off gas slip stream is not recirculated in the recirculation system.

198. The system of clause 196, any other suitable clause, or any combination of suitable clauses, wherein the anode off gas slip stream is mixed with a cathode off gas.

199. The system of clause 196, any other suitable clause, or any combination of suitable clauses, wherein the anode off gas slip stream is oxidized in a catalyst.

200. The system of clause 195, any other suitable clause, or any combination of suitable clauses, wherein the recirculation system comprises a motive force.

201. The system of clause 200, any other suitable clause, or any combination of suitable clauses, wherein the motive force is provided by a blower, one or more ejectors, or some combination of a blower and one or more ejectors.

202. The system of clause 201, any other suitable clause, or any combination of suitable clauses, wherein the blower is an anode off gas recirculation blower.

203. The system of clause 201, any other suitable clause, or any combination of suitable clauses, wherein the one or more ejectors is a fuel-driven ejector or a steam-driven ejector.

204. The system of clause 201, any other suitable clause, or any combination of suitable clauses, wherein the fuel-driven ejector requires high fuel pressure.

205. The system of clause 201, any other suitable clause, or any combination of suitable clauses, wherein the steam-driven ejector does not rely on the anode off gas slip stream.

206. The system of clause 201, any other suitable clause, or any combination of suitable clauses, wherein the steam-driven ejector relies on the anode off gas recirculation system.

207. The system of clause 201, any other suitable clause, or any combination of suitable clauses, wherein the one or more steam-driven ejectors are configured to selectively engage or disengage based on a value of one or more operating parameters.

208. The system of clause 207, any other suitable clause, or any combination of suitable clauses, wherein the one or more operating parameters are pressure, system power, system voltage, fuel flow rate, and steam flow rate.

209. The system of clause 201, any other suitable clause, or any combination of suitable clauses, wherein the ejectors are of a same size, different size, or some combination of ejectors of the same size and different sizes.

210. The system of clause 201, any other suitable clause, or any combination of suitable clauses, wherein a size of each ejector depends on a combination of a first amount of steam input and a second amount of anode gas input to drive each ejector.

211. The system of clause 210, any other suitable clause, or any combination of suitable clauses, wherein an absolute value of the combined input amount to drive the ejector corresponds to the physical size or a capacity of the ejector.

212. The system of clause 210, any other suitable clause, or any combination of suitable clauses, wherein the ejector has a larger combined input amount, output amount, or input and output amount and is physically larger than an ejector with a smaller combined input amount, output amount, or input and output amount.

213. The system of clause 201, any other suitable clause, or any combination of suitable clauses, wherein the one or more ejectors include a first ejector and a second ejector, and/or a third ejector.

214. The system of clause 213, any other suitable clause, or any combination of suitable clauses, wherein a first size of the first ejector is different from or greater than a second size of the second ejector.

215. The system of clause 213, any other suitable clause, or any combination of suitable clauses, wherein a third size of the third ejector is different from the first size, the second size, or the first size and the second size.

216. The system of clause 213, any other suitable clause, or any combination of suitable clauses, wherein the first ejector, the second ejector and the third ejector are operably coupled to the superheater.

217. The system of clause 213, any other suitable clause, or any combination of suitable clauses, wherein the first ejector is in direct fluid communication with the steam supply and receives all or at least a portion of the anode off gas or the anode steam stream.

218. The system of clause 213, any other suitable clause, or any combination of suitable clauses, wherein the first ejector operates as a primary motive force for the recirculation system.

219. The system of clause 201, any other suitable clause, or any combination of suitable clauses, wherein the one or more ejectors of different sizes allow the amount of steam to vary proportionally with the amount of fuel.

220. The system of clause 201, any other suitable clause, or any combination of suitable clauses, wherein the one or more ejectors are operating near their own corresponding critical point or Mach 1.

221. The system of clause 195, any other suitable clause, or any combination of suitable clauses, wherein the recirculation system comprises a fuel source, a reformer, a fuel mixer.

222. The system of clause 221, any other suitable clause, or any combination of suitable clauses, wherein the fuel source provides fuel to the reformer via the fuel mixer.

223. The system of clause 222, any other suitable clause, or any combination of suitable clauses, wherein the fuel is hydrocarbon.

224. The system of clause 221, any other suitable clause, or any combination of suitable clauses, wherein the reformer is configured to break down complex hydrocarbons present in a stream of fuel and steam and to increase a calorific value of the stream of fuel and steam.

225. The system of clause 221, any other suitable clause, or any combination of suitable clauses, wherein the reformer outputs a hydrogen-rich gas or reformate stream to an anode of the fuel cell.

226. The system of clause 221, any other suitable clause, or any combination of suitable clauses, wherein the fuel mixer connects to the one or more steam-driven ejectors.

227. The system of clause 226, any other suitable clause, or any combination of suitable clauses, wherein the one or more steam-driven ejectors cause the anode recirculation gas to be mixed via the fuel mixer with the input fuel stream directed to the reformer and the inlet of the anode.

228. The system of clause 221, any other suitable clause, or any combination of suitable clauses, wherein a heat exchanger is disposed between the fuel mixer and the reformer.

229. The system of clause 228, any other suitable clause, or any combination of suitable clauses, wherein the heat exchanger is a high temperature heat exchanger.

230. The system of clause 228, any other suitable clause, or any combination of suitable clauses, wherein the heat exchanger is configured to heat input fuel and the recirculated anode off gas received from the fuel mixer to generate a higher energy fuel-rich steam stream prior to outputting or directing the steam stream to the reformer.

231. The system of clause 228, any other suitable clause, or any combination of suitable clauses, wherein the heat exchanger derives thermal energy from the anode outlet before a flow splitter.

232. The system of clause 231, any other suitable clause, or any combination of suitable clauses, wherein the flow splitter is operably coupled to the anode of the fuel cell.

233. The system of clause 231, any other suitable clause, or any combination of suitable clauses, wherein the flow splitter is configured to receive an anode off gas from the anode of the fuel cell.

234. The system of clause 231, any other suitable clause, or any combination of suitable clauses, wherein the flow splitter is operably coupled to the one or more ejectors and the superheater.

235. The system of clause 231, any other suitable clause, or any combination of suitable clauses, wherein the flow splitter is operably coupled to the one or more ejectors and provides all or a portion of the anode off gas directly to the one or more ejectors.

236. The system of clause 231, any other suitable clause, or any combination of suitable clauses, wherein the flow splitter is configured to split or divide the anode off gas into at least two portions.

237. The system of clause 231, any other suitable clause, or any combination of suitable clauses, wherein the flow splitter is configured to split or divide an anode off gas stream into a first portion and a second portion.

238. The system of clause 231, any other suitable clause, or any combination of suitable clauses, wherein the flow splitter allows the first portion of the anode off gas or the anode recirculation gas to one or more ejectors.

239. The system of clause 231, any other suitable clause, or any combination of suitable clauses, wherein the flower splitter allows the second portion of the anode off gas or the anode slip stream to the superheater.

240. The system of clause 231, any other suitable clause, or any combination of suitable clauses, wherein the flow splitter allows the first portion of the anode off gas or the anode recirculation gas to the one or more ejectors and wherein the flower splitter allows the second portion of the anode off gas or the anode slip stream to the superheater.

241. The system of clause 231, any other suitable clause, or any combination of suitable clauses, wherein the flow splitter is operably coupled to the one or more ejectors and provides all or a portion of the anode recirculation gas or the anode off gas directly to the one or more ejector.

242. The system of clause 231, any other suitable clause, or any combination of suitable clauses, wherein the flow splitter is operably coupled to the one or more ejectors and provides all or a portion of the anode recirculation gas or the anode off gas not directed by a second flow splitter to the superheater directly to the one or more ejectors.

243. The system of clause 231, any other suitable clause, or any combination of suitable clauses, wherein the flow splitter is operably coupled to the second ejector via a first check valve and/or is operably coupled to the third ejector via a second check valve.

244. The system of clause 243, any other suitable clause, or any combination of suitable clauses, wherein the first check valve and/or the second check valve is a passive valve configured to prevent exhaust gases from flowing back toward the second flow splitter when sufficient steam is not flowing through the second ejector.

245. The system of clause 195, any other suitable clause, or any combination of suitable clauses, wherein the fuel cell is a solid oxide fuel cell (SOFC), phosphoric acid fuel cell (PAFC), molten carbonate fuel cell (MCFC), and a proton exchange membrane fuel cell (PEMFC).

246. The system of clause 245, any other suitable clause, or any combination of suitable clauses, wherein the fuel cell is a solid oxide fuel cell (SOFC).

247. The system of clause 245, any other suitable clause, or any combination of suitable clauses, wherein the fuel cell is a proton exchange membrane fuel cell (PEMFC).

248. The system of clause 195, any other suitable clause, or any combination of suitable clauses, wherein the superheater is located or disposed upstream from a boiler.

249. The system of clause 248, any other suitable clause, or any combination of suitable clauses, wherein the boiler is configured to generate steam.

250. The system of clause 249, any other suitable clause, or any combination of suitable clauses, wherein at least a portion of the generated steam is directed back to the superheater

251. The system of clause 249, any other suitable clause, or any combination of suitable clauses, wherein the steam is divided between one or more ejector, or one or more of the first ejector, the second ejector, and the third ejector.

252. The system of clause 248, any other suitable clause, or any combination of suitable clauses, wherein the boiler is configured to direct at least a portion of the cooler anode off gas or anode slip stream to the condenser.

253. The system of clause 248, any other suitable clause, or any combination of suitable clauses, wherein the boiler includes a first float control valve to direct water to the condenser sump pump in response to the amount of water in the boiler being greater than a predefined amount as indicated by a float of the first float valve.

254. The system of clause 248, any other suitable clause, or any combination of suitable clauses, wherein the boiler is operably coupled to a cathode exhaust, a water drain line, or a cathode exhaust and a water drain line configured to spray or drain water in response to excess water in the condenser sump pump being greater than a threshold amount as indicated by a float of a second float control valve.

255. The system of clause 195, any other suitable clause, or any combination of suitable clauses, wherein the superheater can extract thermal energy from the anode off gas slip stream before the off gas is directed into the boiler or a condenser.

256. The system of clause 255, any other suitable clause, or any combination of suitable clauses, wherein the condenser is configured to cause water in the cooler anode off gas or anode slip stream to condense in a condenser sump pump.

257. The system of clause 256, any other suitable clause, or any combination of suitable clauses, wherein the condenser sump pump is configured to pump liquid water to the boiler.

258. The system of clause 255, any other suitable clause, or any combination of suitable clauses, wherein the condenser condenses the water to a predefined dew point associated with the condenser.

259. The system of clause 255, any other suitable clause, or any combination of suitable clauses, wherein the condenser directs the condensed or dried cool anode off gas or anode slip stream into a cathode oxidizer.

260. The system of clause 255, any other suitable clause, or any combination of suitable clauses, wherein the condenser receives cooling air from a cathode blower before entering a cathode heat exchanger.

261. The system of clause 195, any other suitable clause, or any combination of suitable clauses, wherein the superheater can establish thermodynamically favorable conditions for the steam-driven ejector.

262. The system of clause 195, any other suitable clause, or any combination of suitable clauses, wherein the superheater regulates thermal energy with respect to the amount of water available in the boiler.

263. The system of clause 195, any other suitable clause, or any combination of suitable clauses, wherein the superheater receives the second portion of anode off gas or the anode slip stream from the flow splitter.

264. The system of clause 195, any other suitable clause, or any combination of suitable clauses, wherein the superheater is configured to lower a temperature of the anode off gas or the anode slip stream before the anode off gas or the anode slip stream enters the boiler.

265. The system of clause 195, any other suitable clause, or any combination of suitable clauses, wherein the superheater directs a cooler anode off gas or anode slip stream to the boiler.

266. The system of clause 195, any other suitable clause, or any combination of suitable clauses, wherein the superheater directs steam received from the boiler to the one or more ejectors.

267. The system of clause 195, any other suitable clause, or any combination of suitable clauses, wherein the superheater directs, provides, or is configured to selectively, direct, provide, or divide steam or superheated steam to one or more ejectors, or one or more of the first ejector, the second ejector, and the third ejector.

268. The system of clause 267, any other suitable clause, or any combination of suitable clauses, wherein the steam or superheated steam is selectively divided between the first ejector, the second ejector, and the third ejector.

269. The system of clause 195, any other suitable clause, or any combination of suitable clauses, wherein the superheater receives a portion of the steam in response to the one or more control valves being open.

270. The system of clause 195, any other suitable clause, or any combination of suitable clauses, wherein the superheater is coupled to the second ejector via the first control valve and/or is coupled to the third ejector via the second control valve.

271. The system of clause 195, any other suitable clause, or any combination of suitable clauses, wherein the at least one ejector includes the one or more ejectors.

272. The system of clause 195, any other suitable clause, or any combination of suitable clauses, wherein the control valve includes one or more control valves.

273. The system of clause 272, any other suitable clause, or any combination of suitable clauses, wherein the one or more control valves are operatively operably coupled to the superheater.

274. The system of clause 272, any other suitable clause, or any combination of suitable clauses, wherein the one or more control valves are a pressure control valve or an electronic signal control valve.

275. The system of clause 272, any other suitable clause, or any combination of suitable clauses, wherein the one or more control valves control the proportion of steam going to the first ejector, the second ejector, and/or the third ejector.

276. The system of clause 272, any other suitable clause, or any combination of suitable clauses, wherein the one or more control valves are opened by the first ejector, the second ejector, and/or the third ejector in response to a value of the one or more operating parameters being greater than a threshold or in response to a corresponding electronic signal.

277. The system of clause 272, any other suitable clause, or any combination of suitable clauses, wherein the one or more control valves are selectively opened in response to the first ejector, the second ejector, and/or the third ejector to direct a portion of the steam to the superheater that directs the portion of the steam to the second ejector and/or the third ejector.

278. The system of clause 272, any other suitable clause, or any combination of suitable clauses, wherein the one or more control valves include a first control valve and/or a second control valve.

279. The system of clause 278, any other suitable clause, or any combination of suitable clauses, wherein the first control valve and/or the second control valve open and close in response to corresponding changes in values of one or more operating parameters.

280. The system of clause 278, any other suitable clause, or any combination of suitable clauses, wherein the first control valve and/or the second control valve is opened in response to a value of the one or more operating parameters being greater than a first threshold and/or second threshold, a corresponding electronic signal, or a corresponding electronic command.

281. The system of clause 280, any other suitable clause, or any combination of suitable clauses, wherein the first threshold is less than the second threshold.

282. The system of clause 278, any other suitable clause, or any combination of suitable clauses, wherein the first control valve and/or the second control valve is selectively opened to direct a portion of a steam flow to the conduit of the superheater operably coupled to the second ejector and/or the third ejector.

283. The system of clause 282, any other suitable clause, or any combination of suitable clauses, wherein the steam flow is divided between the first ejector, the second ejector, and/or the third ejector.

284. The system of clause 278, any other suitable clause, or any combination of suitable clauses, wherein the first control valve operably coupled to the second ejector or the second control valve operably coupled to the third ejector closes due to a reduction or proportional reduction in a pressure of the steam.

285. The system of clause 272, any other suitable clause, or any combination of suitable clauses, wherein the one or more control valves are spring loaded valves that selectively open with a change in a value of the one or more operating parameters, venturi controlled valves, or electronically controlled valves.

286. The system of clause 195, any other suitable clause, or any combination of suitable clauses, wherein the recirculation system is implemented in hardware, firmware, software or a combination of hardware, firmware, and/or software.

287. The system of clause 195, any other suitable clause, or any combination of suitable clauses, wherein the recirculation system is implemented as instructions carried by or stored on one or more transitory or non-transitory machine-readable storage mediums and/or one or more transitory or non-transitory computer-readable storage mediums

288. The system of clause 287, any other suitable clause, or any combination of suitable clauses, wherein the one or more transitory or non-transitory machine-readable storage mediums are any storage device, mechanism, or other physical structure for storing or transmitting information in a form readable by a machine, a volatile or non-volatile memory, a media disc, another media device, or any combination of the above.

289. The system of clause 287, any other suitable clause, or any combination of suitable clauses, wherein the one or more transitory or non-transitory computer-readable storage mediums are any storage device, mechanism, or other physical structure for storing or transmitting information in a form readable by a computer, a volatile or non-volatile memory, a media disc, another media device, or any combination of the above.

290. The system of clause 287, any other suitable clause, or any combination of suitable clauses, wherein the one or more transitory or non-transitory machine-readable storage mediums and/or the one or more transitory or non-transitory computer-readable storage mediums are read and executed by one or more processors.

1. A recirculation system for a fuel cell assembly, the system comprising:
a flow splitter operably coupled to an anode of the fuel cell and configured to receive an anode off gas therefrom;
a superheater disposed downstream from the flow splitter and configured to cool a portion of the anode off gas received through the flow splitter; and
a boiler operably coupled to the superheater and configured to receive the portion of the anode off gas cooled by the superheater,
wherein the boiler is configured to generate steam and direct at least a portion of the generated steam to the superheater, and
wherein the superheater is configured to use the portion of the generated steam to drive an ejector.

2. The system of claim 1, further comprising a condenser operably coupled to the boiler and configured to supply water thereto, such that the condenser operates as a sole source of water for the boiler.

3. The system of claim 2, further comprising a condenser sump pump operably coupled to the condenser and configured to collect and deliver the water to the boiler.

4. The system of claim 1, wherein the portion of the anode off gas cooled by the superheater is a first portion, the flow splitter is operably coupled to the ejector, and the flow splitter directs a second portion of the anode off gas to the ejector.

5. The system of claim 1, wherein the ejector comprises a plurality of ejectors operably coupled to a fuel mixer.

6. The system of claim 5, wherein the superheater is fluidly coupled to at least one ejector of the plurality of ejectors, such that the superheater at all times provides steam to drive the at least one ejector of the plurality of ejectors.

7. The system of claim 5, further comprising a control valve operably coupled to an input end of a conduit of the superheater, wherein an output end of the conduit is operably coupled to at least one ejector of the plurality of ejectors, such that, in response to a value of an operating parameter being less than a threshold, the control valve is closed preventing steam from entering the input end of the conduit and preventing the superheater from driving the at least one ejector of the plurality of ejectors.

8. A method for recirculating an anode off gas in a fuel cell assembly, the method comprising:
receiving, at a flow splitter, the anode off gas generated by an anode of a fuel cell;
directing, at the flow splitter, a portion of the received anode off gas to a superheater;
cooling, at the superheater, the portion of the anode off gas received from the flow splitter and directing at least a portion of the cooled portion of the anode off gas to a boiler;
generating, at the boiler, steam and directing at least a portion of the generated steam to the superheater; and
driving an ejector at least in part using at least a portion of the generated steam received by the superheater.

9. The method of claim 8, further comprising supplying, by a condenser, water to the boiler, such that at least a portion of the generated steam is generated using the supplied water.

10. The method of claim 9, wherein the water is supplied to the boiler by a condenser sump pump coupled to the condenser and disposed downstream from the boiler.

11. The method of claim 8, wherein the portion of the anode off gas received by the superheater comprises an anode off gas slip stream.

12. The method of claim 8, wherein the flow splitter is operably coupled to the ejector, wherein the flow splitter divides the received anode off gas into at least two portions, wherein the portion of the anode off gas received and cooled by the superheater is a first portion of the at least two portions, and wherein the flow splitter directs a second portion of the at least two portions to the ejector.

13. The method of claim 8, wherein the ejector comprises a plurality of ejectors operably coupled to a fuel mixer.

14. The method of claim 13, wherein driving the ejector during operation comprises driving one ejector of the plurality of ejectors coupled to the superheater.

15. The method of claim 13, further comprising, in response to a value of an operating parameter being less than a threshold, causing a control valve to close to prevent steam from entering an input end of a conduit of the superheater and prevent driving at least one ejector of the plurality of ejectors coupled to an output end of the conduit.

16. The method of claim 15, further comprising, in response to the value of the operating parameter being greater than a threshold, causing the control valve to open to permit steam to enter the input end of the conduit and permit driving the at least one ejector of the plurality of ejectors coupled to the output end of the conduit.

17. A recirculation system for a fuel cell assembly, the system comprising:
a superheater comprising a plurality of conduits extending therethrough;
a plurality of ejectors, each ejector operably coupled to an output side of at least one conduit of the plurality of conduits and configured to provide a motive force for recirculating an anode off gas output by an anode of a fuel cell; and
a control valve operably coupled to an input side of at least one conduit of the plurality of conduits, wherein, in response to a value of an operating parameter being greater than a threshold, the control valve opens to permit steam to flow to the input side of the at least one conduit of the plurality of conduits, and wherein the superheater drives the ejector operably coupled to the output side of the at least one conduit of the plurality of conduits.

18. The system of claim 17, wherein the operating parameter includes at least one of a pressure, a system power, a system voltage, a fuel flow rate, or a steam flow rate.

19. The system of claim 17, wherein, in response to the value of the operating parameter being less than a threshold, the control valve closes to prevent steam flow to the input side of the at least one conduit of the plurality of conduits and to prevent the superheater from driving the ejector operably coupled to the output side of the at least one conduit of the plurality of conduits.

20. The system of claim 17, wherein the input side of another conduit of the plurality of conduits is configured to receive directly steam provided by the boiler, such that, in response to the value being less than threshold, at least a portion of the steam flow is directed to the ejector operably coupled to the output side of the another conduit of the plurality of conduits.
